(19) United States
(12) Patent Application Publication
(10) Pub. No.: US 2026/0059348 A1
(43) Pub. Date: Feb. 26, 2026

(54) ENERGY SAVING USING PREDICTED PERFORMANCE INDICATORS

(71) Applicant: QUALCOMM Incorporated, San Diego, CA (US)

(72) Inventors: Gal IZHAKI, Haifa (IL); Andrei VADEANU, Bucharest (RO); Daniel YELLIN, Raanana (IL)

(21) Appl. No.: 18/812,849

(22) Filed: Aug. 22, 2024

(51) Int. Cl. H04W 24/02; H04L 41/16; H04W 28/08; H04W 52/02

(52) U.S. Cl. CPC H04W 24/02; H04L 41/16; H04W 28/0942; H04W 28/0983; H04W 52/0206

(57) ABSTRACT

This disclosure provides systems, methods, and apparatus for energy saving using predicted performance indicators. The described techniques may enable a service management and orchestration framework (SMO) to determine one or more cells to deactivate based on one or more predicted key performance indicators (KPIs) associated with deactivating the cells. For example, the SMO may use a machine learning (ML) model, a neural network (NN), and the like to predict how a throughput associated with the one or more cells may change based on deactivating a first cell for a first period of time. In some aspects, the SMO may therefore predict a first time period or a threshold load for to deactivate the first cell that may result in a throughput of one or more other cells decreasing an amount that is less than a threshold throughput decrease.

### TECHNICAL FIELD

This disclosure relates to wireless communications, including energy saving using predicted performance indicators.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-s-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method by a device associated with service management of a wireless network. The method may include receiving one or more threshold performance metrics associated with data throughput in a set of multiple cells of the wireless network, receiving an indication of one or more observed performance indicators associated with the data throughput of the set of multiple cells, and outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

Another innovative aspect of the subject matter described in this disclosure can be implemented in a device associated with service management of a wireless network. The device associated with service management of a wireless network may include one or more memories storing processor executable code, and one or more processors coupled with the one or more memories. The one or more processors may individually or collectively be operable to execute the code to cause the device associated with service management of a wireless network to receive one or more threshold performance metrics associated with data throughput in a set of multiple cells of the wireless network, receive an indication of one or more observed performance indicators associated with the data throughput of the set of multiple cells, and output an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

Another innovative aspect of the subject matter described in this disclosure can be implemented in a device associated with service management of a wireless network. The device associated with service management of a wireless network may include means for receiving one or more threshold performance metrics associated with data throughput in a set of multiple cells of the wireless network, means for receiving an indication of one or more observed performance indicators associated with the data throughput of the set of multiple cells, and means for outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

Another innovative aspect of the subject matter described in this disclosure can be implemented in a non-transitory computer-readable medium storing code. The code may include instructions executable by one or more processors to receive one or more threshold performance metrics associated with data throughput in a set of multiple cells of the wireless network, receive an indication of one or more observed performance indicators associated with the data throughput of the set of multiple cells, and output an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

In some examples of the method, device associated with service management of a wireless networks, and non-transitory computer-readable medium described herein, the instruction to deactivate the one or more cells may be in accordance with the one or more predicted performance indicators falling below the one or more threshold performance metrics.

In some examples of the method, device associated with service management of a wireless networks, and non-transitory computer-readable medium described herein, the instruction to activate the one or more cells may be in accordance with the one or more predicted performance indicators exceeding the one or more threshold performance metrics.

In some examples of the method, device associated with service management of a wireless networks, and non-transitory computer-readable medium described herein, the one or more threshold performance metrics associated with the data throughput in the set of multiple cells includes one or more of a threshold throughput, a threshold throughput decrease, or a threshold confidence level associated with the one or more predicted performance indicators.

Some examples of the method, device associated with service management of a wireless networks, and non-transitory computer-readable medium described herein may further include operations, features, means, or instructions for obtaining the one or more predicted performance indicators in accordance with the one or more observed performance indicators.

In some examples of the method, device associated with service management of a wireless networks, and non-transitory computer-readable medium described herein, a physical location of the set of multiple cells, one or more beams used by the set of multiple cells, an azimuth associated with the set of multiple cells, a distribution of one or more frequency layers across the set of multiple cells, one or more carrier frequencies used by the set of multiple cells, one or more transmission bandwidths used by the set of multiple cells, one or more transmission powers used by the set of multiple cells, a carrier aggregation associated with the set of multiple cells, one or more priorities associated with the set of multiple cells, a quantity of radio resource control users associated with the set of multiple cells, a quantity of radio resource control scheduled users associated with the set of multiple cells, a quantity of physical resource blocks utilized by the set of multiple cells, a quantity of user equipments (UEs) served by the set of multiple cells, a volume of traffic associated with the set of multiple cells, an average throughput of the set of multiple cells, or any combination thereof.

In some examples of the method, device associated with service management of a wireless networks, and non-transitory computer-readable medium described herein, the one or more predicted performance indicators may be obtained using a machine learning (ML) model and the ML model may be trained based on the one or more observed performance indicators.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports energy saving using predicted performance indicators.

FIG. 2 shows an example of a cell diagram of a wireless communications system that supports energy saving using predicted performance indicators.

FIG. 3 shows an example of a throughput diagram of a wireless communications system that supports energy saving using predicted performance indicators.

FIG. 4 shows an example of an energy saving analysis using predicted performance indicators.

FIG. 5 shows a block diagram of an example device that supports energy saving using predicted performance indicators.

FIG. 6 shows a diagram of an example system including a device that supports energy saving using predicted performance indicators.

FIGS. 7 and 8 show flowcharts illustrating methods that support energy saving using predicted performance indicators.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G), fifth generation (5G), or sixth generation (6G), or further implementations thereof, technology.

In some wireless communication systems, one or more cells of one or more network entities may form a distributed self-organized network (dSON) that may operate in one or more frequency layers. For example, a first set of cells may provide service to one or more user equipments (UEs) in a first frequency layer, a second set of cells may provide service to one or more UEs in a second frequency layer, and so on. In some examples, the dSON may reduce power consumption by deactivating one or more frequency layers (such as deactivating one or more cells operating in the one or more frequency layers). However, such techniques may result in the remaining frequency layers experiencing an increase in traffic, which may result in relatively reduced throughput of the wireless communication system (such as below a threshold throughput allowed by a mobile network operator (MNO)).

Various aspects generally relate to a service management and orchestration (SMO) or edgewise (EW) framework associated with the dSON that may determine which cells (or which frequency layers) to deactivate based on one or more predicted key performance indicators (KPIs) (such as predicted throughputs, predicted loads) associated with deactivating the cells. Various aspects relate more specifically to methods for one or more management entities (such as the SMO or an EW suite) to use a machine learning (ML) model, a neural network (NN), and the like to predict how a throughput associated with the one or more cells may change based on deactivating one or more cells (or one or more frequency layers) within a sector (such as a same direction, azimuth, and angle). In some examples, MNO may configure the management entity with a margin (such as a confidence level) associated with the predicted KPI. The ML model or NN may accordingly output a range of predicted KPIs associated with the margin, and the management device may determine a time period to deactivate the first cell for which a throughput associated with an upper bound of the range of predicted KPIs does not fall below the configured throughput threshold. In some aspects, the management entity may use the predicted KPI (or the predicted range of KPI) predict a threshold load of the first cell at which the dSON may deactivate the first cell that may result in a throughput of the dSON decreasing to a throughput that is more than a threshold throughput allowed by the MNO. In some examples, the threshold load may be associated with a first time. The management entity may use the predicted KPI (or the predicted range of KPI) to predict a second threshold load of the first cell at which the dSON may reactivate the first cell. In some examples, the second threshold load may be associated with a second time.

Particular aspects of the subject matter described in this disclosure may be implemented to realize one or more of the following potential advantages. The techniques employed by the described communication devices may provide benefits and enhancements to the operation of the communication devices, including relatively reduced power consumption with relatively less reduction in quality of communications. For example, operations performed by the described communication devices may decrease power consumption by enabling one or more cells (or one or more frequency layers) to be disabled. Operations performed by the described communication devices may prevent relatively high decreases in a quality of communications by preventing a throughput associated with one or more cells from decreasing below a threshold as a result of the disabling. In some implementations, operations performed by the described communication devices also may support improvements to reliability, increased coordination between devices, and improved utilization of resources, among other benefits, by allowing the management entity to use a ML model to determine a time period and/or one or more threshold loads for which one or more cells may be disabled, and by allowing the management entity to predict the one or more threshold loads with a confidence level configured by the MNO (such that the MNO may specify an allowed reduction in performance for uplink or downlink traffic).

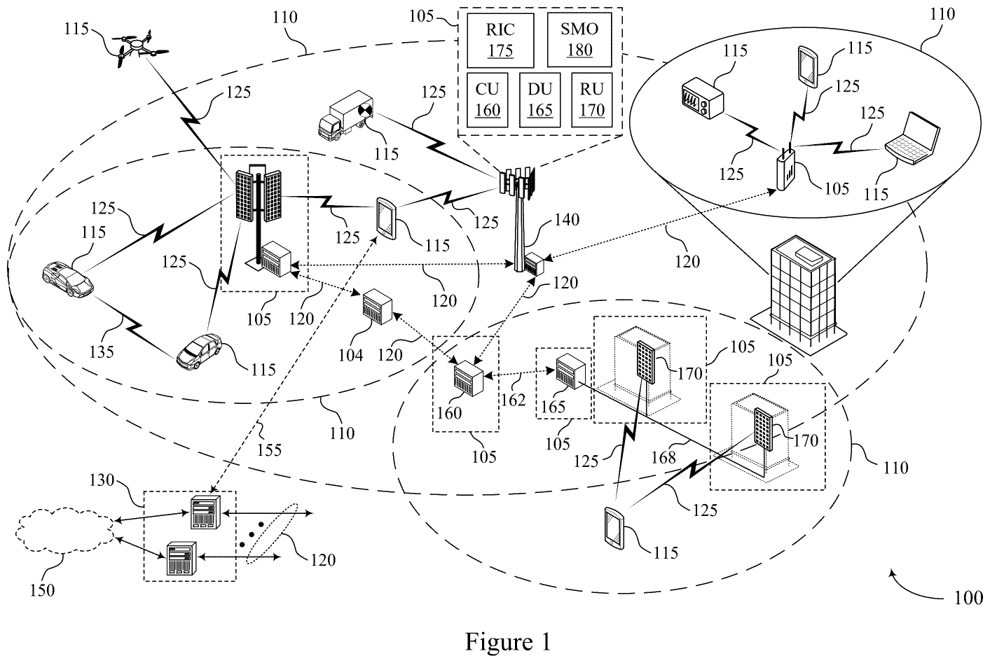

FIG. 1 shows an example of a wireless communications system 100 that supports energy saving using predicted performance indicators. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or another interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a SMO 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support energy saving using predicted performance indicators as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

In some implementations, such as in a carrier aggregation configuration, a carrier also may have acquisition signaling or control signaling that coordinates operations for other carriers. A carrier may be associated with a frequency channel (such as an evolved universal mobile telecommunication system terrestrial radio access (E-UTRA) absolute RF channel number (EARFCN)) and may be identified according to a channel raster for discovery by the UEs 115. A carrier may be operated in a standalone mode, for which initial acquisition and connection may be conducted by the UEs 115 via the carrier, or the carrier may be operated in a non-standalone mode, for which a connection is anchored using a different carrier (such as of the same or a different radio access technology).

The communication links 125 shown in the wireless communications system 100 may include downlink transmissions (such as forward link transmissions) from a network entity 105 to a UE 115, uplink transmissions (such as return link transmissions) from a UE 115 to a network entity 105, or both, among other configurations of transmissions. Carriers may carry downlink or uplink communications (such as in an FDD mode) or may be configured to carry downlink and uplink communications (such as in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (such as 1.4, 3, 5, 10, 15, 20, 40, or 80 megahertz (MHz)). Devices of the wireless communications system 100 (such as the network entities 105, the UEs 115, or both) may have hardware configurations that support communications using a particular carrier bandwidth or may be configurable to support communications using one of a set of carrier bandwidths. In some implementations, the wireless communications system 100 may include network entities 105 or UEs 115 that support concurrent communications using carriers associated with multiple carrier bandwidths. In some implementations, each served UE 115 may be configured for operating using portions (such as a sub-band, a BWP) or all of a carrier bandwidth.

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some implementations, a UE 115 may be configured with multiple BWPs. In some implementations, a single BWP for a carrier may be active at a given time and communications for the UE 115 may be restricted to one or more active BWPs.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered BS 140), as compared with a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and also may support communications via the one or more cells using one or multiple component carriers.

In some implementations, a carrier may support multiple cells, and different cells may be configured according to different protocol types (such as MTC, narrowband IoT (NB-IoT), enhanced mobile broadband (eMBB)) that may provide access for different types of devices.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 or network entities 105 may be configured to employ operating modes that reduce power consumption, such as half-duplex communications (such as a mode that supports one-way communication via transmission or reception, but not transmission and reception concurrently). In some implementations, half-duplex communications may be performed at a reduced peak rate. Other power conservation techniques for the UEs 115 and network entities 105 include entering a power saving deep sleep mode when not engaging in active communications, operating using a limited bandwidth (such as according to narrowband communications), or a combination of these techniques. For example, some UEs 115 may be configured for operation using a narrowband protocol type that is associated with a defined portion or range (such as set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 also may operate using a super high frequency (SHF) region, which may be in the range of 3 GHz to 30 GHz, also known as the centimeter band, or using an extremely high frequency (EHF) region of the spectrum (such as from 30 GHz to 300 GHz), also known as the millimeter band. In some implementations, the wireless communications system 100 may support millimeter wave (mmW) communications between the UEs 115 and the network entities 105 (such as BSs 140, RUs 170), and EHF antennas of the respective devices may be smaller and more closely spaced than UHF antennas. In some implementations, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a BS 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some implementations, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a BS 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned along a beam direction determined based on listening according to different receive configuration directions (such as a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Certain aspects and techniques as described herein may be implemented, at least in part, using an artificial intelligence (AI) program, such as a program that includes a ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform KPI prediction based on one or more observed KPIs and one or more other attributes of a dSON as described herein. Thus, during operation of a device, the ML model may receive input data (such as observed KPI, physical characteristics of the dSON, a configuration of the dSON, and performance parameters of the dSON) and make inferences (such as a predicted KPI) based on the weights and biases.

ML models may be deployed in one or more devices (such as SMOs, network entities, and UEs) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models to predict KPI. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In example aspects, an ML model may be trained prior to, or at some point following, operation of the ML model on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE 115 or other device in a wireless communication system, or one or more network entities, or aggregated from multiple sources (such as a UE 115 and a network entity/entities 105, one or more other UEs 115, the Internet, or the like). For example, wireless network architectures, such as self-organizing networks (SONs) (such as dSONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

In some examples of the wireless communications system 100, an management entity (such as a SMO associated with a dSON or xApp, an EW suite, and the like) that may determine which cells (or which frequency layers) to deactivate based on one or more predicted KPIs associated with deactivating the cells. The management entity may use a ML model, a NN, or another model to predict how a throughput associated with the one or more cells may change based on deactivating a first cell (or a first frequency layer) for a first period of time. In some aspects, the SMO may therefore predict a first time period to deactivate the first cell that may result in a throughput of the wireless communications system 100 decreasing an amount that is less than a threshold throughput decrease allowed by the MNO. In some examples, MNO may configure the management device with a margin (such as a confidence level) associated with the predicted KPI. The ML model or NN may accordingly output a range of predicted KPIs associated with the margin, and the management device may determine a time period to deactivate the first cell for which a throughput associated with an upper bound of the range of predicted KPIs does not fall below the configured throughput threshold.

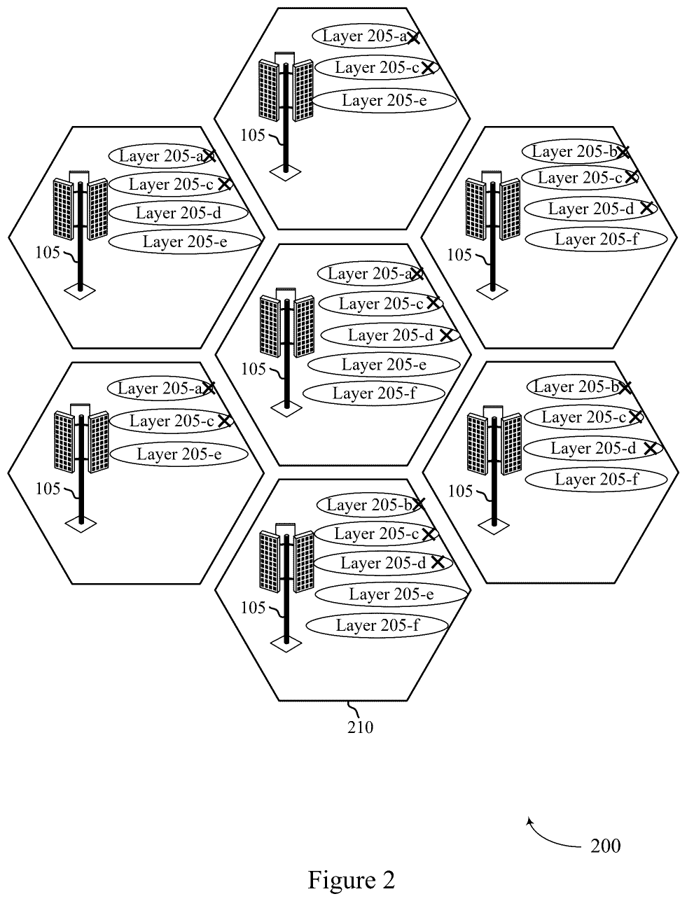

FIG. 2 shows an example of a cell diagram 200 in a wireless communications system that supports energy saving using predicted performance indicators. The cell diagram 200 may implement or may be implemented by aspects of the wireless communications system 100 described with reference to FIG. 1. For example, the cell diagram 200 may be implemented by one or more network entities 105 and an SMO or EW suite, which may be examples of the corresponding devices as described with reference to FIG. 1.

In some examples of the cell diagram 200, one or more network entities 105 may operate (in a dSON or xApp) in a corresponding one or more sectors 210. For example, the network entities 105 may communicate with UEs 115 that are located in the sectors 210. Each of the network entities 105 may transmit messages to the UEs 115 and receive messages from the UEs 115 via one or more frequency layers 205 (such as one or more of a frequency layer 205-a through a frequency layer 205-f). As an illustrative example, the frequency layers 205 may include a 2600 MHz layer, a 2100 MHz layer, an 1800 MHz layer, a 1500 MHz layer, a 900 MHz layer, and an 800 MHz layer. In some examples, a first subset of the frequency layers 205 (such as one or more higher frequency layers 205, which may include a frequency layer 205-a, a frequency layer 205-b, a frequency layer 205-c, a frequency layer 205-d) may be capacity layers, and a second subset of the frequency layers (such as one or more lower frequency layers 205, which may include a frequency layer 205-e and a frequency layer 205-f) may be coverage layers. As described herein, capacity layers may be frequency layers 205 that have a relatively larger channel capacity and a relatively smaller coverage area, and coverage layers may be frequency layers 205 that have a relatively smaller channel capacity and a relatively larger coverage area.

In some examples, however, a sector 210 that communicates via relatively more frequency layers 205 may use relatively more power consumption than a sector 210 that communicates via relatively fewer frequency layers 205. Accordingly, the network entities 105 in the sectors 210 may operate in an energy saving mode in which a device associated with management of the dSON (a management device such as an SMO or an EW suite) may instruct one or more of the network entities 105 in the sectors 210 and/or one or more of the frequency layers 205 to be deactivated (such as via direct switch off of the cells of the network entities 105 or of an orchestrating feature of the dSON), which may result in relatively less power consumption of the sectors 210. In some examples, the management device may instruct the network entities 105 in the sectors 210 to deactivate during low traffic hours (such as a low traffic time period during which a load of the dSON may be relatively smaller than a high traffic time period). Accordingly, the network entities 105 in the sectors 210 may deactivate one or more of the capacity layers, and one or more users (such as UEs) that are communicating via the capacity layers may shift to the coverage layers (such as the frequency layers 205 that are not deactivated).

In some examples, an MNO associated with the dSON may provide one or more performance thresholds (such as a threshold throughput, a threshold throughput degradation, a confidence level) to the management device such that the management device may not orchestrate a cell deactivation that may result in a throughput of the one or more sectors 210 falling more than a threshold amount below a throughput of the one or more cells prior to the cell deactivation. As an illustrative example, the MNO may instruct the management device to deactivate network entities 105 in the sectors 210 such that a load of the one or more sectors 210 may not cause more than a 10% throughput degradation of the sectors 210. Accordingly, the management device may not deactivate one or more network entities 105 in the sectors 210 (such as one or more frequency layers 205), which may reduce energy savings of the dSON.

Accordingly, the management device may determine a load associated with the capacity layers (such as a load of the capacity cells) for which a throughput of the coverage layers may not degrade more than the threshold throughput degradation after deactivating the capacity layers. For example, the management device may predict a throughput (or a throughput degradation) that may be experienced by the coverage layers as a result of switching off (such as deactivating) a capacity layer. The management device may use the predicted throughput (or throughput degradation) to determine a threshold load of the capacity layers for which the management device may deactivate the capacity layers without causing a throughput degradation that is more than the threshold throughput degradation. The management device may predict the throughput (or throughput degradation) per-sector (such as per section), where a sector 210 may be a group of cells that may point in a same direction.

In some examples, the management device may use an algorithm (such as a simulator) to generate training data. For example, the management device may input synthetic data (such as with a relatively higher quantity of network permutations than a quantity of network permutations associated with measured data) into a simulator. The management device may accordingly execute one or more network snapshot changes (such as pseudo-random network snapshot changes) that may result from the synthetic data. For example, the synthetic data may include physical data (such as a latitude and longitude associated with the sectors 210, a height of the sectors 210, an azimuth or angle above the ground associated with communications with the sectors 210, a tilt of the sectors 210, one or more beams used in the sectors 210), a layer structure (such as a structure of the frequency layer 205, such as a quantity or distribution of the frequency layers 205 across the sectors 210), and a load state (such as a quantity of users and/or an amount of traffic served by the sector 210). The management device may simulate a configuration change (such as a deactivation of one or more network entities 105 in the sectors 210 and/or the capacity layers) and may accordingly measure, via the simulator, a KPI (such as a throughput change) of the non-deactivated network entities 105 in the sectors 210 (such as the coverage layers).

The management device may use the simulation (such as the training data) to train an ML model or a hybrid NN (HNN) (such as an energy savings(ES) predictor HNN) or deep NN (DNN) that may include one or more jointly trained deep NNs. For example, the management device may input the training data into the DNN to adjust one or more weights or parameters associated with the DNN. The management device may adjust the one or more weights or parameters associated with the DNN such that the training data input into the DNN results in an output that is relatively close to one or more ground-truth labels associated with the training data. The one or more ground-truth labels may include the simulated throughput changes associated with the corresponding simulation input.

The management device may accordingly use the DNN to obtain a first predicted threshold load of the dSON for which to activate energy savings (such as by deactivating one or more network entities 105 in the sectors 210 or the capacity layers) and a second threshold load for which to deactivate energy savings (such as by re-activating the one or more network entities 105 in the sectors 210 or the capacity layers). For example, the management device may input one or more parameters associated with the dSON into the DNN. The one or more parameters may include configuration parameters (such as a confidence level requested by the MNO, carrier frequencies used by the sectors 210, communication bandwidths used by the sectors 210, a transmission power used by the sectors 210, a carrier aggregation used by the sectors 210, one or more priorities of the sectors 210), physical parameters (such as a latitude and longitude of the sectors 210, an azimuth of the sectors 210, a tilt of the sectors 210, one or more beams used by the sectors 210), and performance parameters (such as an average quantity of physical resource blocks (PRBs) used by the sectors 210, an average quantity of UEs 115 served by the sectors 210, KPI data such as an average throughput of the sectors 210, a traffic volume served by the sectors 210, a quantity of RRC users and/or RRC scheduled users served by the sectors 210). The management device may additionally input a frequency layer strategy (such as a layer structure, which may include a quantity of distribution of frequency layers 205 in the sectors 210) and/or one or more performance thresholds (such as the performance thresholds provided by the MNO) into the DNN.

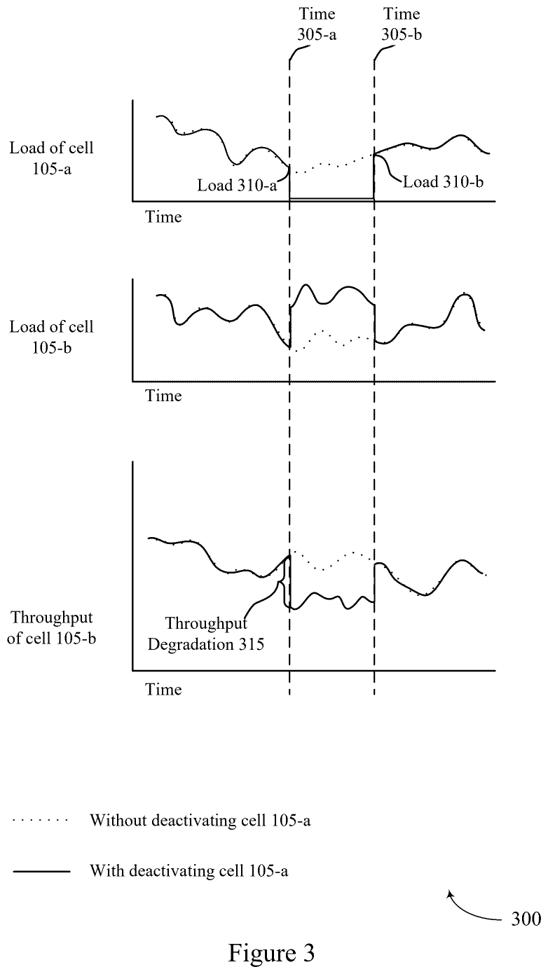

In some examples, an algorithm or application (such as an ES optimizer) may use the DNN to determine and output the first threshold load and the second threshold load for a polygon of cells (such as a group of sectors 210). The first threshold load and the second threshold load may account for a cost and function trade-off between energy consumption and throughput degradation considering cell layouts (such as a co-located layer distribution), physical location (such as a facing direction, surrounding cells and layers), a cell configuration (such as a layer, bandwidth, transmission power, and the like), and current performance management patterns (such as a quantity of users, a throughout, traffic volume, and the like). The first threshold load and the second threshold load may be loads for which a predicted throughput degradation of the coverage layers does not exceed the threshold throughput degradation. An example of such threshold loads and corresponding throughput changes is illustrated with reference to FIG. 3. In some examples, the ES optimizer may be a reinforcement learner (RL) with an action space that includes an action associated with turning on a cell and an action associated with turning off a cell, cell compensation steps (such as tilting up, tilting down, increasing transmission power, decreasing transmission power, and the like) for traffic balancing that may enable relatively more cells (or capacity layers) to be switched off without exceeding the threshold throughput degradation. In such examples, the ES optimizer may account for user throughput as part of a cost function analysis.

The management device may obtain, from the ES DNN (or from the ES optimizer which may use the ES DNN), a first time at which to turn off one or more cells corresponding to the first threshold load, a second time at which to turn on one or more cells corresponding to the second threshold load, and/or an energy savings score associated with deactivating the one or more cells. Accordingly, the management device may output an instruction to deactivate one or more network entities 105 in the sectors 210 (such as one or more frequency layers 205, such as the capacity layers) at the first time corresponding to the first threshold load of the sectors 210. The one or more network entities 105 in the sectors 210 may deactivate in accordance with the instruction, which may result in a change (such as a decrease) in energy consumption of the sectors 210. The management device may output an instruction to activate (such as reactivate) the one or more cells at the second time corresponding to the second threshold load. The one or more network entities 105 in the sectors 210 may reactivate in accordance with the instruction, which may result a throughput of the sectors 210 remaining above the threshold throughput indicated by the MNO (such as with a throughput degradation that is less than the threshold throughput degradation indicated by the MNO).

In some examples, the management device may provide, to the ES optimizer, a confidence level (such as the confidence level indicated by the MNO) associated with throughput degradation prediction. As an illustrative, the MNO may indicate for the management device to predict the throughput degradation with a confidence of 80%.

The ES optimizer may accordingly generate one or more upper and lower bounds associated with the throughput degradation (such as bounds within which the DNN determines that the throughput degradation of the coverage layers will fall with a probability of 80%). For example, within the upper and lower bounds, the DNN may predict that the throughput degradation of the coverage layers falls outside of the threshold throughput degradation 20% of the time. The first threshold load and the second threshold load may be based on the upper and lower bounds. For example, the ES optimizer may determine the first threshold load and the second threshold load such that the throughput degradation may not exceed the threshold degradation indicated by the MNO when the capacity layers are deactivated at the first threshold load until the second threshold load with a probability corresponding to the confidence level.

In some examples, the DNN may output a predicted change in energy consumption of the sectors 210. For example, the DNN may include a KPI prediction model to perform a traffic prediction (such as to predict a change in load of the sectors 210), a “real-time what-if scenario” model to perform a network impact predication (such as a predicted throughput degradation associated with deactivating the capacity layers), and a “real-time ML energy savings predictor” model to perform an energy savings prediction (such as whether an energy savings associated with deactivating the capacity layers is above a threshold energy savings). The DNN may accordingly obtain the first threshold load and the second threshold load that are determined based on (such as optimized according to) the energy savings prediction. The management device may accordingly determine whether to deactivate the capacity layers based on whether the predicted energy savings is sufficient (such as above the threshold energy savings).

FIG. 3 shows an example of a throughput diagram 300 of a wireless communications system that supports energy saving using predicted performance indicators. The throughput diagram 300 may implement or may be implemented by aspects of the wireless communications system 100 described with reference to FIG. 1 or the cell diagram 200 described with reference to FIG. 2. For example, the throughput diagram 300 may be implemented by one or more network entities 105 (such as a cell 105-a and a cell 105-b associated with one or more network entities 105) and a management device such as an SMO or EW suite, which may be examples of the corresponding devices as described with reference to FIG. 1.

In some examples, as described with reference to FIG. 2, a management device (such as an SMO or an EW suite) may use one or more algorithms (such as a simulator, an ML model, a NN, an HNN, a DNN) to predict how a throughput of a cell 105-b may change based on deactivating a cell 105-a. For example, the DNN may receive one or more parameters associated with the cell 105-a and the cell 105-b (such as physical parameters, configuration parameters, performance parameters, and a confidence level as described with reference to FIG. 2). The DNN may accordingly generate a predicted load of the cell 105-a, a predicted load of the cell 105-b, and a predicted throughput of the cell 105-b for examples in which the cell 105-a is not deactivated. The DNN may additionally, or alternatively, generate a predicted load of the cell 105-a a predicted load of the cell 105-b (such as a load associated with switching one or more users operating on the cell 105-a to the cell 105-b), and a predicted throughput of the cell 105-b for examples in which the cell 105-a is deactivated for a period of time. For example, the DNN may estimate an amount by which the load of the cell 105-b may increase between a time 305-a and a time 305-b based on deactivating the cell 105-a. The DNN may accordingly estimate an amount by which the throughput of the cell 105-b may decrease (such as a throughput degradation 315) between the time 305-a and the time 305-b based on deactivating the cell 105-a. The cell 105-a may be a capacity cell associated with one or more capacity layers (such as relatively higher capacity and lower coverage frequency layers) and the cell 105-b may be a coverage cell associated with one or more coverage layers (such as relatively higher coverage and lower capacity frequency layers).

The ES optimizer may use the estimations provided by the DNN to determine the time 305-a and the time 305-b for which the throughput degradation 315 is less than a threshold throughput degradation (such as a threshold throughput degradation indicated by an MNO to the management device, such as 10%). The ES optimizer may accordingly determine a network configuration that adheres to an intent of the MNO (such as increasing an energy saving score while maintaining a throughput reduction within an allowed margin reduction percentage, such as the threshold throughput degradation.) For example, the ES optimizer may determine a threshold load 310-a (such as a load 310-a corresponding to the time 305-a) for which the cell 105-a may be deactivated and a threshold load 310-b (such as a load 310-b corresponding to the time 305-b) for which the cell 105-a may be reactivated such that the throughput degradation 315 is less than the threshold throughput degradation. The ES optimizer may output the load 310-a and the load 310-b to the management device such that the management device may output a first instruction to deactivate the cell 105-a when the load of the cell 105-a is the load 310-a and a second instruction to reactivate the cell 105-a when the load of the cell 105-a is predicted to be the load 310-b. As described herein, deactivating the cell 105-a may refer to deactivating the one or more capacity layers such that one or more users operating in the one or more capacity layers may be switched to the one or more coverage layers.

In some examples, the ES optimizer may generate the predicted load of the cell 105-a the predicted load of the cell 105-b, and the predicted throughput of the cell 105-b with upper and lower bounds. For example, the MNO may provide the management device with a confidence level for which to predict the throughput degradation 315. Accordingly, the management device may instruct the ES optimizer to output the load 310-a and the load 310-b for which a predicted upper bound (such as an upper bound associated with the confidence level) of the throughput degradation 315 is less than the threshold throughput degradation.

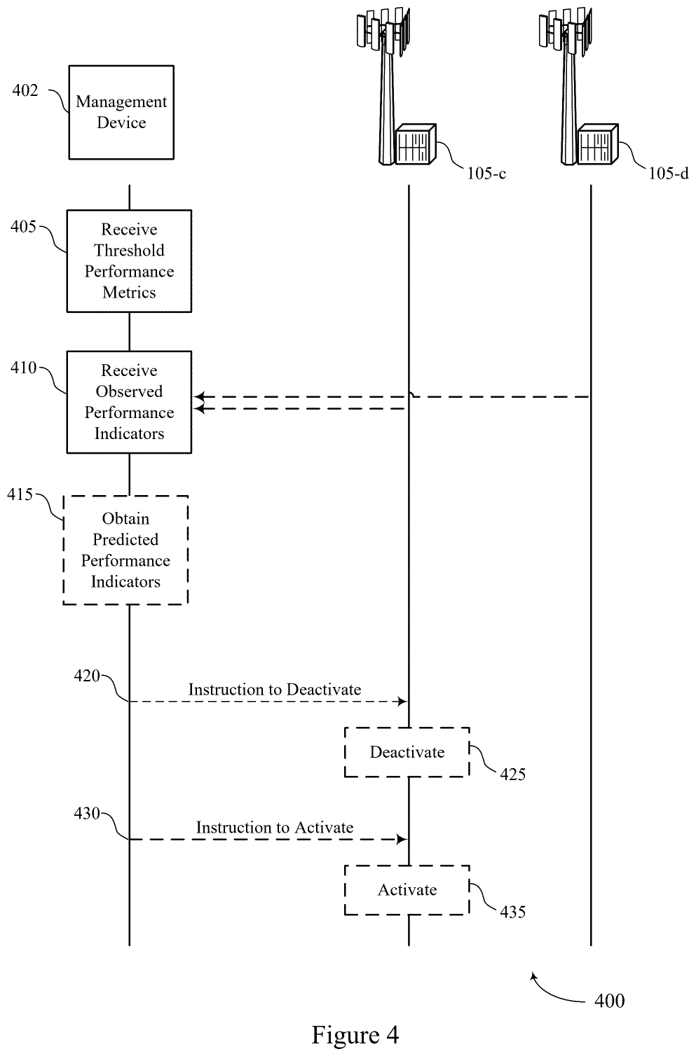

FIG. 4 shows an example of a an energy saving analysis 400 using predicted performance indicators. The energy saving analysis 400 may implement or may be implemented by aspects of the wireless communications system 100 described with reference to FIG. 1, the cell diagram 200 described with reference to FIG. 1, or the throughput diagram 300 described with reference to FIG. 3. For example, the energy saving analysis 400 may be implemented by one or more network entities 105 (such as a network entity 105-c and a network entity 105-d) and a management device 402 (such as an SMO or EW suite), which may be examples of the corresponding devices as described with reference to FIG. 1. Although the energy saving analysis 400 is illustrated with reference to two network entities 105 in a dSON (such as the network entity 105-c and the network entity 105-d), in some examples, one or more additional network entities 105 of the dSON may implement the energy saving analysis 400.

In the following description of the energy saving analysis 400, the operations between the network entity 105-c, the network entity 105-d, and the management device 402 may occur in a different order than the example order shown and, in some examples, may be performed by one or more different devices other than those shown as examples. Some operations also may be omitted from the energy saving analysis 400, and other operations may be added to the energy saving analysis 400. Further, although some operations or signaling may be shown to occur at different times for discussion purposes, these operations may actually occur at the same time.

At 405, the management device 402 may receive one or more threshold performance metrics associated with one or more cells of one or more network entities 105 (such as a cell of a network entity 105-c, a cell of a network entity 105-d, one or more additional network entities 105). For example, the one or more threshold performance metrics may be associated with data throughput of the one or more cells. In some examples, the one or more threshold performance metrics may include a threshold throughput of the one or more cells (such as a minimum throughput of the one or more cells), a threshold throughput decrease of the one or more cells (such as a percentage by which a throughput of the one or more network entities 105 may decrease), a threshold confidence level of one or more predicted performance indicators, and the like. In some examples, the one or more cells may be associated with a plurality of frequency layers.

At 410, the management device 402 may receive one or more observed performance indicators of the one or more network entities 105. For example, the management device 402 may receive the one or more observed performance metrics from the network entity 105-c and/or the network entity 105-d. The one or more observed performance metrics may include an observed KPI (such as a current KPI, a previous KPI) of the one or more cells. The one or more observed performance metrics may be associated with a throughput of the one or more cells (such as a current throughput, a previous throughput).

In some examples, at 415, the management device 402 may obtain one or more predicted performance indicators of the one or more cells. For example, the management device 402 may receive the one or more predicted performance indicators (such as from another device associated with the dSON) or may generate the one or more predicted performance indicators using an algorithm (such as an ML model, an NN). In some examples, the algorithm (such as the ML model, the NN) may be trained based on the one or more observed performance indicators.

The management device 402 may input the observed performance indicators and one or more parameters associated with the one or more cells into the algorithm. For example, the one or more observed performance indicators may be used by the algorithm to determine one or more weights or parameters associated with the algorithm (such as via a training procedure associated with the algorithm), and the one or more parameters associated with the one or more cells may be inputs into the algorithm. The one or more predicted performance indicators of the one or more cells may be outputs of the algorithm.

The one or more parameters associated with the one or more cells may include a target confidence level configured by the MNO, physical parameters (such as physical location of the one or more cells, one or more beams used by the one or more network entities 105 in the one or more cells, an azimuth associated with the one or more cells, a distribution of one or more frequency layers across the one or more cells), one or more configuration parameters (one or more carrier frequencies used in the one or more cells, one or more transmission bandwidths used in the one or more cells, one or more transmission powers used in the one or more cells, a carrier aggregation associated with the one or more cells, one or more priorities associated with the one or more cells), and/or one or more performance-related parameters (such as quantity of RRC scheduled users associated with the one or more cells, a quantity of PRBs utilized by the one or more cells, a quantity of UEs served by the one or more cells, a volume of traffic associated with the one or more cells, an average throughput of the one or more cells).

In some examples, the management device 402 may input the one or more threshold performance metrics into the algorithm. For example, the management device 402 may indicate the threshold throughput of the one or more cells, a threshold throughput decrease of the one or more cells, and/or the threshold confidence level of the one or more predicted performance indicators into the algorithm. The algorithm may accordingly output a time period during which the management device 402 may deactivate one or more of the one or more cells (such as one or more frequency layers associated with the one or more cells), a threshold load for disabling the one or more of the one or more cells, and/or a confidence level (such as an upper and lower bound) of the predicted performance indicators in accordance with the one or more threshold performance metrics.

In some examples, at 420, the management device 402 may output an instruction to the network entity 105-c (such as and/or to one or more additional network entities) to deactivate a cell of the network entity 105-c (such as and the one or more additional network entities). The instruction may be based on an effect of the instruction on a collective energy consumption of the one or more network entities 105. For example, the instruction may cause the collective energy consumption of the one or more network entities 105 to decrease.

The management device 402 may output the instruction to deactivate the cell of the network entity 105-c in accordance with a predicted performance indicator (or an upper bound of the predicted performance indicator) of a cell of the network entity 105-d being below the one or more performance metrics. For example, the management device 402 may output the instruction to deactivate the cell of the network entity 105-c based on the one or more predicted performance metrics indicating that a throughput of the cell of the network entity 105-d will decrease an amount that is below the threshold throughput decrease. In some examples, the management device 402 may output the instruction to deactivate the network entity 105-c at a first time (such as a time corresponding to a first threshold load of the cell associated with the network entity 105-c or the network entity 105-d). In some examples, the instruction may indicate for the network entity 105-c to deactivate a frequency layer of the plurality of frequency layers associated with the cell. Accordingly at 425, the network entity 105-c may deactivate the cell (or may deactivate the frequency layer).

In some examples, at 430, the management device 402 may output an instruction to the network entity 105-c (such as and/or to one or more additional network entities) to activate the cell of the network entity 105-c (such as and the one or more additional network entities). The management device 402 may output the instruction to activate the cell of the network entity 105-c in accordance with a predicted performance indicator (or an upper bound of the predicted performance indicator) of the cell of the network entity 105-d being above the one or more performance metrics. For example, the management device 402 may output the instruction to activate the cell of the network entity 105-c based on the one or more predicted performance metrics indicating that the throughput of the cell of the network entity 105-d will decrease an amount that is above the threshold throughput decrease. In some examples, the management device 402 may output the instruction to activate the network entity 105-c at a second time (such as a time corresponding to a second threshold load of the cell associated with the network entity 105-c or the network entity 105-d). In some examples, the instruction may indicate for the network entity 105-c to activate a frequency layer associated with the cell. Accordingly at 435, the network entity 105-c may activate the cell (or may activate the frequency layer).

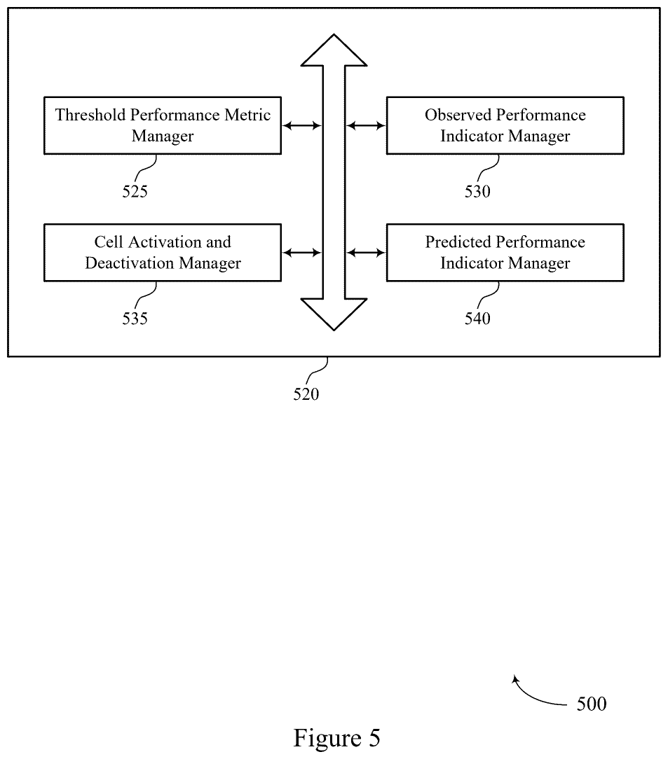

FIG. 5 shows a block diagram 500 of an example device 520 that supports energy saving using predicted performance indicators. The device 520 may be an example of or implement aspects of a network entity as described with reference to FIGS. 1 through 4. The device 520, or various components thereof, may be an example of means for performing various aspects of energy saving using predicted performance indicators as described herein. For example, the device 520 may include a threshold performance metric manager 525, an observed performance indicator manager 530, a cell activation and deactivation manager 535, a predicted performance indicator manager 540, or any combination thereof. Each of these components, or components or subcomponents thereof (such as one or more processors, one or more memories), may communicate, directly or indirectly, with one another (such as via one or more buses). The communications may include communications within a protocol layer of a protocol stack, communications associated with a logical channel of a protocol stack (such as between protocol layers of a protocol stack, within a device, component, or virtualized component associated with a network entity 105, between devices, components, or virtualized components associated with a network entity 105), or any combination thereof.

The threshold performance metric manager 525 may be capable of, configured to, or operable to support a means for receiving one or more threshold performance metrics associated with data throughput in a set of multiple cells of the wireless network. The observed performance indicator manager 530 may be capable of, configured to, or operable to support a means for receiving an indication of one or more observed performance indicators associated with the data throughput of the set of multiple cells. The cell activation and deactivation manager 535 may be capable of, configured to, or operable to support a means for outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

In some examples, the instruction to deactivate the one or more cells is in accordance with the one or more predicted performance indicators falling below the one or more threshold performance metrics.

In some examples, the instruction to activate the one or more cells is in accordance with the one or more predicted performance indicators exceeding the one or more threshold performance metrics.

In some examples, the one or more threshold performance metrics associated with the data throughput in the set of multiple cells includes one or more of a threshold throughput, a threshold throughput decrease, or a threshold confidence level associated with the one or more predicted performance indicators.

In some examples, the predicted performance indicator manager 540 is capable of, configured to, or operable to support a means for obtaining the one or more predicted performance indicators in accordance with the one or more observed performance indicators.

In some examples, a physical location of the set of multiple cells, one or more beams used by the set of multiple cells, an azimuth associated with the set of multiple cells, a distribution of one or more frequency layers across the set of multiple cells, one or more carrier frequencies used by the set of multiple cells, one or more transmission bandwidths used by the set of multiple cells, one or more transmission powers used by the set of multiple cells, a carrier aggregation associated with the set of multiple cells, one or more priorities associated with the set of multiple cells, a quantity of radio resource control users associated with the set of multiple cells, a quantity of radio resource control scheduled users associated with the set of multiple cells, a quantity of physical resource blocks utilized by the set of multiple cells, a quantity of user equipments (UEs) served by the set of multiple cells, a volume of traffic associated with the set of multiple cells, an average throughput of the set of multiple cells, or any combination thereof.

In some examples, the one or more predicted performance indicators are obtained using a machine learning (ML) model. In some examples, the ML model is trained based on the one or more observed performance indicators.

In some examples, to support outputting the instruction to activate or deactivate the one or more cells of the set of multiple cells, the cell activation and deactivation manager 535 is capable of, configured to, or operable to support a means for outputting a first instruction to deactivate the one or more cells at a first time. In some examples, to support outputting the instruction to activate or deactivate the one or more cells of the set of multiple cells, the cell activation and deactivation manager 535 is capable of, configured to, or operable to support a means for outputting a second instruction to activate the one or more cells at a second time, where the first time and the second time are in accordance with the one or more predicted performance indicators.

In some examples, the first time and the second time are associated with a first threshold load of the set of multiple cells and a second threshold load of the set of multiple cells.

In some examples, the one or more cells are associated with a first frequency layer, the one or more predicted performance indicators are associated with one or more second frequency layers, and the instruction to activate or deactivate the one or more cells of the set of multiple cells in accordance with the one or more predicted performance indicators includes an instruction to deactivate the one or more cells.

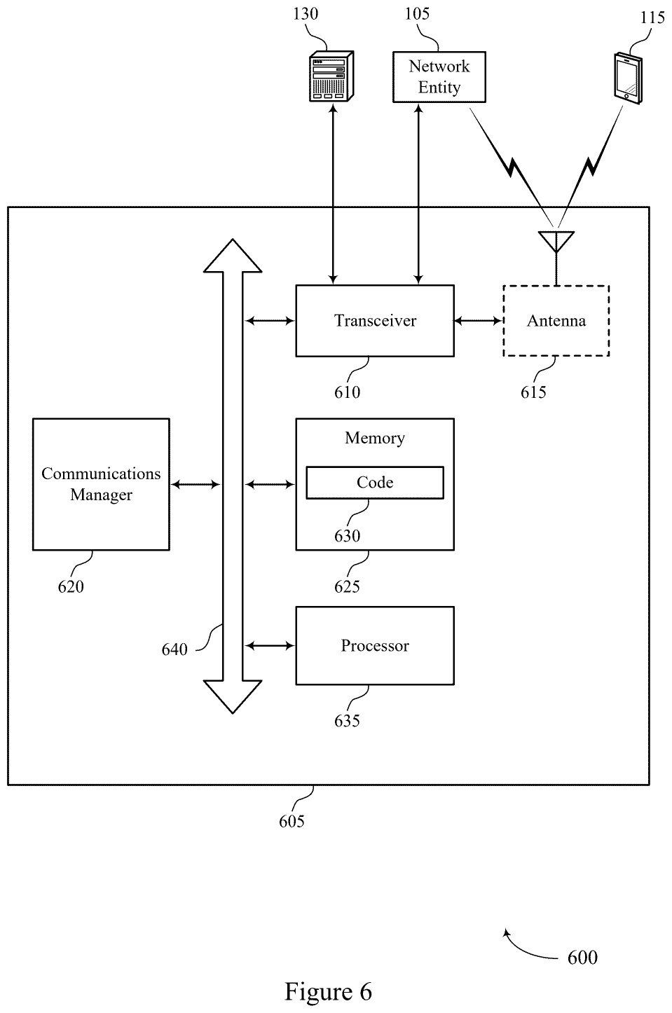

FIG. 6 shows a diagram of an example system 600 including a device 605 that supports energy saving using predicted performance indicators. The device 605 may communicate with one or more network entities (such as one or more components of one or more BSs 140), one or more UEs 115, or any combination thereof, which may include communications over one or more wired interfaces, over one or more wireless interfaces, or any combination thereof. The device 605 may include components that support outputting and obtaining communications, such as a communications manager 620, a transceiver 610, one or more antennas 615, at least one memory 625, code 630, and at least one processor 635. These components may be in electronic communication or otherwise coupled (such as operatively, communicatively, functionally, electronically, electrically) via one or more buses (such as a bus 640).

The transceiver 610 may support bi-directional communications via wired links, wireless links, or both as described herein. In some examples, the transceiver 610 may include a wired transceiver and may communicate bi-directionally with another wired transceiver. Additionally, or alternatively, in some examples, the transceiver 610 may include a wireless transceiver and may communicate bi-directionally with another wireless transceiver. In some examples, the device 605 may include one or more antennas 615, which may be capable of transmitting or receiving wireless transmissions (such as concurrently). The transceiver 610 also may include a modem to modulate signals, to provide the modulated signals for transmission (such as by one or more antennas 615, by a wired transmitter), to receive modulated signals (such as from one or more antennas 615, from a wired receiver), and to demodulate signals. In some implementations, the transceiver 610 may include one or more interfaces, such as one or more interfaces coupled with the one or more antennas 615 that are configured to support various receiving or obtaining operations, or one or more interfaces coupled with the one or more antennas 615 that are configured to support various transmitting or outputting operations, or a combination thereof. In some implementations, the transceiver 610 may include or be configured for coupling with one or more processors or one or more memory components that are operable to perform or support operations based on received or obtained information or signals, or to generate information or other signals for transmission or other outputting, or any combination thereof. In some implementations, the transceiver 610, or the transceiver 610 and the one or more antennas 615, or the transceiver 610 and the one or more antennas 615 and one or more processors or one or more memory components (such as the at least one processor 635, the at least one memory 625, or both), may be included in a chip or chip assembly that is installed in the device 605. In some examples, the transceiver 610 may be operable to support communications via one or more communications links (such as communication link(s) 125, backhaul communication link(s) 120, a midhaul communication link 162, a fronthaul communication link 168).

The at least one memory 625 may include RAM, ROM, or any combination thereof. The at least one memory 625 may store computer-readable, computer-executable, or processor-executable code, such as the code 630. The code 630 may include instructions that, when executed by one or more of the at least one processor 635, cause the device 605 to perform various functions described herein. The code 630 may be stored in a non-transitory computer-readable medium such as system memory or another type of memory. In some examples, the code 630 may not be directly executable by a processor of the at least one processor 635 but may cause a computer (such as when compiled and executed) to perform functions described herein. In some examples, the at least one memory 625 may include, among other things, a BIOS which may control basic hardware or software operation such as the interaction with peripheral components or devices. In some examples, the at least one processor 635 may include multiple processors and the at least one memory 625 may include multiple memories.

One or more of the multiple processors may be coupled with one or more of the multiple memories which may, individually or collectively, be configured to perform various functions herein (as part of a processing system).

The at least one processor 635 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some examples, the at least one processor 635 may be configured to operate a memory array using a memory controller. In some other cases, a memory controller may be integrated into one or more of the at least one processor 635. The at least one processor 635 may be configured to execute computer-readable instructions stored in a memory (such as one or more of the at least one memory 625) to cause the device 605 to perform various functions (such as functions or tasks supporting energy saving using predicted performance indicators). For example, the device 605 or a component of the device 605 may include at least one processor 635 and at least one memory 625 coupled with one or more of the at least one processor 635, the at least one processor 635 and the at least one memory 625 configured to perform various functions described herein. The at least one processor 635 may be an example of a cloud-computing platform (such as one or more physical nodes and supporting software such as operating systems, virtual machines, or container instances) that may host the functions (such as by executing code 630) to perform the functions of the device 605. The at least one processor 635 may be any one or more suitable processors capable of executing scripts or instructions of one or more software programs stored in the device 605 (such as within one or more of the at least one memory 625).

In some examples, the at least one processor 635 may include multiple processors and the at least one memory 625 may include multiple memories. One or more of the multiple processors may be coupled with one or more of the multiple memories, which may, individually or collectively, be configured to perform various functions herein. In some examples, the at least one processor 635 may be a component of a processing system, which may refer to a system (such as a series) of machines, circuitry (including, for example, one or both of processor circuitry (which may include the at least one processor 635) and memory circuitry (which may include the at least one memory 625)), or components, that receives or obtains inputs and processes the inputs to produce, generate, or obtain a set of outputs. The processing system may be configured to perform one or more of the functions described herein. For example, the at least one processor 635 or a processing system including the at least one processor 635 may be configured to, configurable to, or operable to cause the device 605 to perform one or more of the functions described herein. Further, as described herein, being “configured to,” being “configurable to,” and being “operable to” may be used interchangeably and may be associated with a capability, when executing code stored in the at least one memory 625 or otherwise, to perform one or more of the functions described herein.

In some examples, a bus 640 may support communications of (such as within) a protocol layer of a protocol stack. In some examples, a bus 640 may support communications associated with a logical channel of a protocol stack (such as between protocol layers of a protocol stack), which may include communications performed within a component of the device 605, or between different components of the device 605 that may be co-located or located in different locations (such as where the device 605 may refer to a system in which one or more of the communications manager 620, the transceiver 610, the at least one memory 625, the code 630, and the at least one processor 635 may be located in one of the different components or divided between different components).

In some examples, the communications manager 620 may manage aspects of communications with a core network 130 (such as via one or more wired or wireless backhaul links). For example, the communications manager 620 may manage the transfer of data communications for client devices, such as one or more UEs 115. In some examples, the communications manager 620 may manage communications with one or more other network entities 105, and may include a controller or scheduler for controlling communications with UEs 115 (such as in cooperation with the one or more other network devices). In some examples, the communications manager 620 may support an X2 interface within an LTE/LTE-A wireless communications network technology to provide communication between network entities 105.

For example, the communications manager 620 is capable of, configured to, or operable to support a means for receiving one or more threshold performance metrics associated with data throughput in a set of multiple cells of the wireless network. The communications manager 620 is capable of, configured to, or operable to support a means for receiving an indication of one or more observed performance indicators associated with the data throughput of the set of multiple cells. The communications manager 620 is capable of, configured to, or operable to support a means for outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

In some examples, the communications manager 620 may be configured to perform various operations (such as receiving, obtaining, monitoring, outputting, transmitting) using or otherwise in cooperation with the transceiver 610, the one or more antennas 615 (such as where applicable), or any combination thereof. Although the communications manager 620 is illustrated as a separate component, in some examples, one or more functions described with reference to the communications manager 620 may be supported by or performed by the transceiver 610, one or more of the at least one processor 635, one or more of the at least one memory 625, the code 630, or any combination thereof (such as by a processing system including at least a portion of the at least one processor 635, the at least one memory 625, the code 630, or any combination thereof). For example, the code 630 may include instructions executable by one or more of the at least one processor 635 to cause the device 605 to perform various aspects of energy saving using predicted performance indicators as described herein, or the at least one processor 635 and the at least one memory 625 may be otherwise configured to, individually or collectively, perform or support such operations.

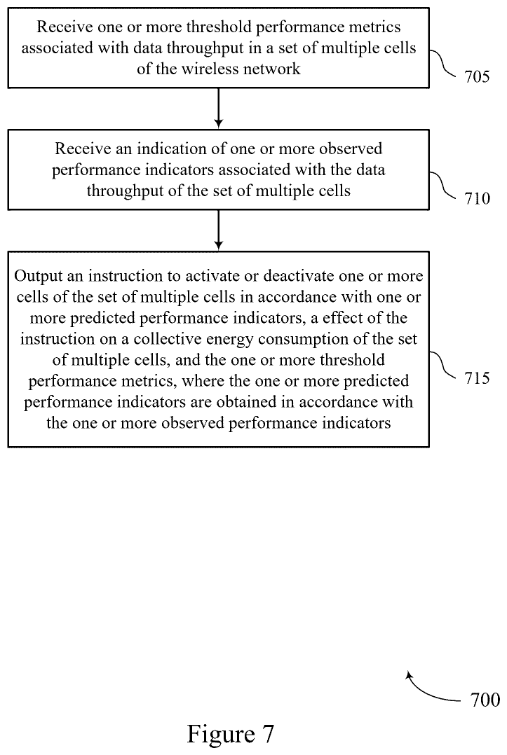

FIG. 7 shows a flowchart illustrating a method 700 that supports energy saving using predicted performance indicators. The operations of the method 700 may be implemented by a network entity or its components as described herein. For example, the operations of the method 700 may be performed by a network entity as described with reference to FIGS. 1 through 6. In some examples, a network entity may execute a set of instructions to control the functional elements of the network entity to perform the described functions. Additionally, or alternatively, the network entity may perform aspects of the described functions using special-purpose hardware.

At 705, the method may include receiving one or more threshold performance metrics associated with data throughput in a set of multiple cells of the wireless network. The operations of 705 may be performed in accordance with examples as disclosed herein. In some examples, aspects of the operations of 705 may be performed by a threshold performance metric manager 525 as described with reference to FIG. 5.

At 710, the method may include receiving an indication of one or more observed performance indicators associated with the data throughput of the set of multiple cells. The operations of 710 may be performed in accordance with examples as disclosed herein. In some examples, aspects of the operations of 710 may be performed by an observed performance indicator manager 530 as described with reference to FIG. 5.

At 715, the method may include outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators. The operations of 715 may be performed in accordance with examples as disclosed herein. In some examples, aspects of the operations of 715 may be performed by a cell activation and deactivation manager 535 as described with reference to FIG. 5.

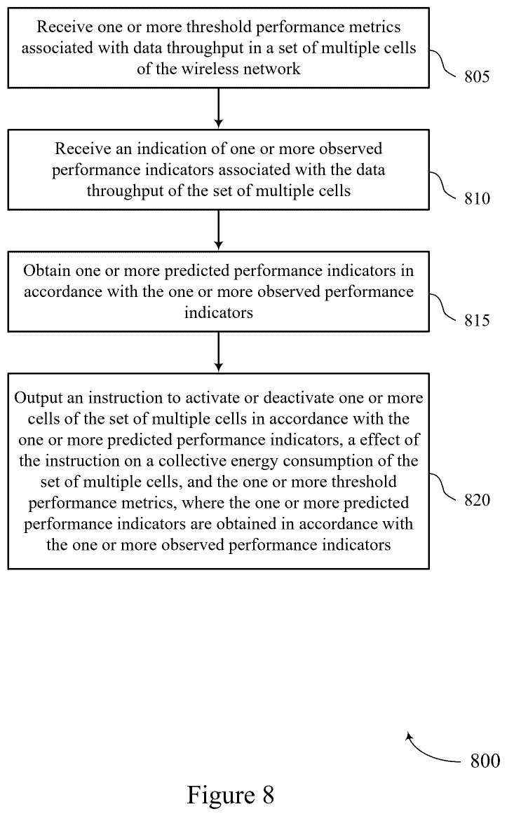

FIG. 8 shows a flowchart illustrating a method 800 that supports energy saving using predicted performance indicators. The operations of the method 800 may be implemented by a network entity or its components as described herein. For example, the operations of the method 800 may be performed by a network entity as described with reference to FIGS. 1 through 6. In some examples, a network entity may execute a set of instructions to control the functional elements of the network entity to perform the described functions. Additionally, or alternatively, the network entity may perform aspects of the described functions using special-purpose hardware.

At 805, the method may include receiving one or more threshold performance metrics associated with data throughput in a set of multiple cells of the wireless network. The operations of 805 may be performed in accordance with examples as disclosed herein. In some examples, aspects of the operations of 805 may be performed by a threshold performance metric manager 525 as described with reference to FIG. 5.

At 810, the method may include receiving an indication of one or more observed performance indicators associated with the data throughput of the set of multiple cells. The operations of 810 may be performed in accordance with examples as disclosed herein. In some examples, aspects of the operations of 810 may be performed by an observed performance indicator manager 530 as described with reference to FIG. 5.

At 815, the method may include obtaining one or more predicted performance indicators in accordance with the one or more observed performance indicators. The operations of 815 may be performed in accordance with examples as disclosed herein. In some examples, aspects of the operations of 815 may be performed by a predicted performance indicator manager 540 as described with reference to FIG. 5.

At 820, the method may include outputting an instruction to activate or deactivate one or more cells of the set of multiple cells in accordance with the one or more predicted performance indicators, an effect of the instruction on a collective energy consumption of the set of multiple cells, and the one or more threshold performance metrics, where the one or more predicted performance indicators are obtained in accordance with the one or more observed performance indicators. The operations of 820 may be performed in accordance with examples as disclosed herein. In some examples, aspects of the operations of 820 may be performed by a cell activation and deactivation manager 535 as described with reference to FIG. 5.

The following provides an overview of some aspects of the present disclosure:

Aspect 1: A method by a device associated with service management of a wireless network, including: receiving one or more threshold performance metrics associated with data throughput in a set of multiple cells of the wireless network; receiving an indication of one or more observed performance indicators associated with the data throughput of the set of multiple cells; and outputting an instruction to activate or deactivate one or more cells of the set of multiple cells in accordance with one or more predicted performance indicators, an effect of the instruction on a collective energy consumption of the set of multiple cells, and the one or more threshold performance metrics, where the one or more predicted performance indicators are obtained in accordance with the one or more observed performance indicators.

Aspect 2: The method of aspect 1, where the instruction to deactivate the one or more cells is in accordance with the one or more predicted performance indicators falling below the one or more threshold performance metrics.

Aspect 3: The method of any of aspects 1 through 2, where the instruction to activate the one or more cells is in accordance with the one or more predicted performance indicators exceeding the one or more threshold performance metrics.

Aspect 4: The method of any of aspects 1 through 3, where the one or more threshold performance metrics associated with the data throughput in the set of multiple cells includes one or more of a threshold throughput, a threshold throughput decrease, or a threshold confidence level associated with the one or more predicted performance indicators.

Aspect 5: The method of any of aspects 1 through 4, further including: obtaining the one or more predicted performance indicators in accordance with the one or more observed performance indicators.

Aspect 6: The method of aspect 5, where the one or more predicted performance indicators are obtained in accordance with one or more of a physical location of the set of multiple cells, one or more beams used by the set of multiple cells, an azimuth associated with the set of multiple cells, a distribution of one or more frequency layers across the set of multiple cells, one or more carrier frequencies used by the set of multiple cells, one or more transmission bandwidths used by the set of multiple cells, one or more transmission powers used by the set of multiple cells, a carrier aggregation associated with the set of multiple cells, one or more priorities associated with the set of multiple cells, a quantity of radio resource control users associated with the set of multiple cells, a quantity of radio resource control scheduled users associated with the set of multiple cells, a quantity of physical resource blocks utilized by the set of multiple cells, a quantity of UEs served by the set of multiple cells, a volume of traffic associated with the set of multiple cells, an average throughput of the set of multiple cells, or any combination thereof.

Aspect 7: The method of any of aspects 5 through 6, where the one or more predicted performance indicators are obtained using a ML model, the ML model is trained based on the one or more observed performance indicators.

Aspect 8: The method of any of aspects 1 through 7, where outputting the instruction to activate or deactivate the one or more cells of the set of multiple cells includes: outputting a first instruction to deactivate the one or more cells at a first time; and outputting a second instruction to activate the one or more cells at a second time, where the first time and the second time are in accordance with the one or more predicted performance indicators.

Aspect 9: The method of aspect 8, where the first time and the second time are associated with a first threshold load of the set of multiple cells and a second threshold load of the set of multiple cells.

Aspect 10: The method of any of aspects 1 through 9, where the one or more cells are associated with a first frequency layer, the one or more predicted performance indicators are associated with one or more second frequency layers, and the instruction to activate or deactivate the one or more cells of the set of multiple cells in accordance with the one or more predicted performance indicators includes an instruction to deactivate the one or more cells.

Aspect 11: A device associated with service management of a wireless network, including: a processing system that includes processor circuitry and memory circuitry that stores code, the processing system configured to cause the device associated with service management of a wireless network to perform a method of any of aspects 1 through 10.

Aspect 12: A device associated with service management of a wireless network, comprising at least one means for performing a method of any of aspects 1-10.

Aspect 13: A non-transitory computer-readable medium storing code, the code including instructions executable by one or more processors to a method of any of aspects 1-10.

Aspect 14: A device associated with service management of a wireless network, including: processing circuitry associated with one or more memory devices and configured to cause the device associated with service management of a wireless network to perform a method of any of aspects 1-10.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c”is intended to cover: a, b, c, a-b, a-c, b-c, and a-b-c.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single-or multi-chip processor, a digital signal processor (DSP), an application specific integrated circuit (ASIC), a graphics processing unit (GPU), a neural processing unit (NPU), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium.

Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. A device associated with service management of a wireless network, comprising:
a processing system that includes processor circuitry and memory circuitry that stores code, the processing system configured to cause the device to:
receive one or more threshold performance metrics associated with data throughput in a plurality of cells of the wireless network;
receive an indication of one or more observed performance indicators associated with the data throughput of the plurality of cells; and
output an instruction to activate or deactivate one or more cells of the plurality of cells in accordance with one or more predicted performance indicators, an effect of the instruction on a collective energy consumption of the plurality of cells, and the one or more threshold performance metrics, wherein the one or more predicted performance indicators are obtained in accordance with the one or more observed performance indicators.

2. The device of claim 1, wherein the instruction to deactivate the one or more cells is in accordance with the one or more predicted performance indicators falling below the one or more threshold performance metrics.

3. The device of claim 1, wherein the instruction to activate the one or more cells is in accordance with the one or more predicted performance indicators exceeding the one or more threshold performance metrics.

4. The device of claim 1, wherein the one or more threshold performance metrics associated with the data throughput in the plurality of cells includes one or more of a threshold throughput, a threshold throughput decrease, or a threshold confidence level associated with the one or more predicted performance indicators.

5. The device of claim 1, wherein the processing system is further configured to cause the device associated with service management of a wireless network to:
obtain the one or more predicted performance indicators in accordance with the one or more observed performance indicators.

6. The device of claim 5, wherein a physical location of the plurality of cells, one or more beams used by the plurality of cells, an azimuth associated with the plurality of cells, a distribution of one or more frequency layers across the plurality of cells, one or more carrier frequencies used by the plurality of cells, one or more transmission bandwidths used by the plurality of cells, one or more transmission powers used by the plurality of cells, a carrier aggregation associated with the plurality of cells, one or more priorities associated with the plurality of cells, a quantity of radio resource control users associated with the plurality of cells, a quantity of radio resource control scheduled users associated with the plurality of cells, a quantity of physical resource blocks utilized by the plurality of cells, a quantity of user equipments (UEs) served by the plurality of cells, a volume of traffic associated with the plurality of cells, an average throughput of the plurality of cells, or any combination thereof.

7. The device of claim 5, wherein the one or more predicted performance indicators are obtained using a machine learning (ML) model, and wherein the ML model is trained based at least in part on the one or more observed performance indicators.

8. The device of claim 1, wherein, to output the instruction to activate or deactivate the one or more cells of the plurality of cells, the processing system is configured to cause the device associated with service management of a wireless network to:
output a first instruction to deactivate the one or more cells at a first time; and
output a second instruction to activate the one or more cells at a second time, wherein the first time and the second time are in accordance with the one or more predicted performance indicators.

9. The device of claim 8, wherein the first time and the second time are associated with a first threshold load of the plurality of cells and a second threshold load of the plurality of cells.

10. The device of claim 1, wherein the one or more cells are associated with a first frequency layer, the one or more predicted performance indicators are associated with one or more second frequency layers, and the instruction to activate or deactivate the one or more cells of the plurality of cells in accordance with the one or more predicted performance indicators includes an instruction to deactivate the one or more cells.

11. A method for service management in a wireless network, comprising:
receiving one or more threshold performance metrics associated with data throughput in a plurality of cells of the wireless network;
receiving an indication of one or more observed performance indicators associated with the data throughput of the plurality of cells; and
outputting an instruction to activate or deactivate one or more cells of the plurality of cells in accordance with one or more predicted performance indicators, an effect of the instruction on a collective energy consumption of the plurality of cells, and the one or more threshold performance metrics, wherein the one or more predicted performance indicators are obtained in accordance with the one or more observed performance indicators.

12. The method of claim 11, wherein the instruction to deactivate the one or more cells is in accordance with the one or more predicted performance indicators falling below the one or more threshold performance metrics.

13. The method of claim 11, wherein the instruction to activate the one or more cells is in accordance with the one or more predicted performance indicators exceeding the one or more threshold performance metrics.

14. The method of claim 11, wherein the one or more threshold performance metrics associated with the data throughput in the plurality of cells includes one or more of a threshold throughput, a threshold throughput decrease, or a threshold confidence level associated with the one or more predicted performance indicators.

15. The method of claim 11, further comprising:
obtaining the one or more predicted performance indicators in accordance with the one or more observed performance indicators.

16. The method of claim 15, wherein the one or more predicted performance indicators are obtained in accordance with one or more of a physical location of the plurality of cells, one or more beams used by the plurality of cells, an azimuth associated with the plurality of cells, a distribution of one or more frequency layers across the plurality of cells, one or more carrier frequencies used by the plurality of cells, one or more transmission bandwidths used by the plurality of cells, one or more transmission powers used by the plurality of cells, a carrier aggregation associated with the plurality of cells, one or more priorities associated with the plurality of cells, a quantity of radio resource control users associated with the plurality of cells, a quantity of radio resource control scheduled users associated with the plurality of cells, a quantity of physical resource blocks utilized by the plurality of cells, a quantity of user equipments (UEs) served by the plurality of cells, a volume of traffic associated with the plurality of cells, an average throughput of the plurality of cells, or any combination thereof.

17. The method of claim 15, wherein the one or more predicted performance indicators are obtained using a machine learning (ML) model, and wherein the ML model is trained based at least in part on the one or more observed performance indicators.

18. The method of claim 11, wherein outputting the instruction to activate or deactivate the one or more cells of the plurality of cells comprises:
outputting a first instruction to deactivate the one or more cells at a first time; and
outputting a second instruction to activate the one or more cells at a second time, wherein the first time and the second time are in accordance with the one or more predicted performance indicators.

19. The method of claim 18, wherein the first time and the second time are associated with a first threshold load of the plurality of cells and a second threshold load of the plurality of cells.

20. The method of claim 11, wherein the one or more cells are associated with a first frequency layer, the one or more predicted performance indicators are associated with one or more second frequency layers, and the instruction to activate or deactivate the one or more cells of the plurality of cells in accordance with the one or more predicted performance indicators includes an instruction to deactivate the one or more cells.
